(19) United States
(12) Patent Application Publication
(10) Pub. No.: US 2012/0132157 A1
(43) Pub. Date: May 31, 2012

(54) Water Jacket Spacer

(75) Inventors: Katsunori MATSUKI, Okayama (JP); Takayuki NAGATO, Okayama (JP); Masayuki MORI, Okayama (JP); Koji MAKINO, Okayama (JP); Takahashi KUBOTA, Aichi (JP)

(73) Assignee: Uchiyama Manufacturing Corp., Okayama (JP)

(21) Appl. No.: 13/305,786

(22) Filed: Nov. 29, 2011

(30) Foreign Application Priority Data
Nov. 29, 2010 (JP) 2010-265459

(51) Int. Cl. F02F 1/14

(52) U.S. Cl. 123/41.79

(57) ABSTRACT

A water jacket spacer has a spacer body molded in conformity to the shape of the water jacket and a regulating member whose one side is fixed to the spacer body. The regulating member is composed of a first member which is not water-swellable and is elastically deformable and a second member made of water-swellable elastomer which is integrally fixed to the first member. The regulating member lies in a state not-contacting an opposed wall of the water jacket when inserted into the water jacket together with the spacer body, whereas it blocks a part of cooling water flowing through the water jacket by deforming such that a side of the regulating member not fixed to the spacer body faces toward the opposed wall of the water jacket when the second member swells by absorbing cooling water flown into the water jacket and thereby the first member is elastically deformed.

### TECHNICAL FIELD

The present invention relates to a water jacket spacer fitted in a water jacket of a cylinder block for regulating the flow volume of cooling water in the water jacket.

### BACKGROUND ART

Cooling structures for internal combustion engines, specifically water-cooled engines of a cylinder block using a water jacket, include an open-type structure and a closed-type structure. The open-type cooling structure is designed such that a water jacket is provided around a cylinder bore of the cylinder block, the water jacket being formed like a loop of which upper part is opened and the planar shape being oval or substantially oval with constriction, cooling water is flown and circulated in the water jacket the upper part of which is closed by being fastened with the cylinder head, thereby cooling an engine block.

The cylinder block is generally produced by casting aluminum alloy and the like. In casting process, a casting material is injected to a casting mold comprising a plurality of divided molds. A part corresponding to the water jacket becomes a male mold according to the structure of the divided molds at casting, the width of the male mold sometimes becomes larger than required for a water jacket depending on the size of the engine (displacement) in order to secure the mold strength of the male mold. As a result, the volume of cooling water in the water jacket sometimes becomes larger than that of cooling water appropriate for the engine. In addition, in case that a plurality of engines with different engine displacement are produced, when one kind of mold can be commonly used for a plurality of engines, expenditure required in producing a high-cost metallic mold can be cut, thereby contributing to reducing the cost required for engines. Patent Literature 1 discloses such technology that in order to commonly use the same mold a water jacket of a cylinder block is formed so as to fit to an engine with largest displacement, several spacers (sleeve in Patent Literature 1) which are molded corresponding to the shape of the water jacket (thickness is different, cutouts are formed, and so on) are appropriately inserted into the water jacket depending on the engine displacement and the capacity in the water jacket is regulated.

Furthermore, Patent Literature 1 discloses that the wall temperature of the cylinder bore varies and the fuel consumption does not stabilize when the spacer vibrates in the water jacket, so that the spacer is constituted with a resin material which absorbs cooling water and swells in such a manner that the spacer is stably kept in the water jacket while being preferably inserted therein, thereby forming an inner projection contacting the inner wall of the water jacket under pressure by such swelling. Hence, the entire spacer disclosed in Patent Literature 1 is constituted with a water-swellable resin material, the inserting performance and fixing ability to the water jacket are improved, but it is difficult to set appropriate flow volume of cooling water in the water jacket because the part other than the inner projection is swollen by cooling water after the spacer is inserted, so that it can be expected that accurate regulation for the volume of cooling water depending on desired engine displacement becomes difficult.

In Patent Literature 2, a water jacket spacer is disclosed such that the spacer has a regulation part comprising a core material and a swellable material which is carried by the core material and swollen by cooling water, swellable direction of the swollen material by cooling water is regulated in the surface area direction of the spacer and is allowed in the substantial width direction. In this disclosure, the material is swollen by the cooling water only in the substantial width direction of the spacer, so that volume of cooling water in the water jacket can be accurately regulated.

Patent Literatures 3 and 4 disclose a spacer which is molded according to the shape of the water jacket and is provided at the lower half in the water jacket, the spacer has a member for separating a flow path up and down (up and down comparting members in Patent Literature 4), and further has an upward guiding member, so that the cylinder bore is prevented from being overcooled at the lower part of the water jacket and cooling in the upper part becomes appropriate. Patent Literatures 5 and 6 disclose a spacer which is provided at an appropriate part in the water jacket (where sand removing bore is formed in Patent Literature 6) in order to prevent non-uniform cooling by cooling water in the water jacket. The spacer is made of a water-swellable material in order to improve attaching performance to the cylinder block and is designed so as to absorb cooling water and swell after being provided in the water jacket, to abut the inner wall of the water jacket, and to regulate flow of cooling water therearound. Patent Literature 7 discloses that the center part of a plate-like cooling regulating member, the bimetal surface of which is coated with resin and the like with low heat conductivity, is fixed to a wall part of the water jacket facing the cylinder bore wall and the flow path of cooling water is regulated by deformation of both free ends accompanied by temperature change in the cooling water flowing in the water jacket.

### CITATION LIST

### Patent Literature

PTL 1 JP-H01-34677-Y
PTL 2 JP-44 65313-B
PTL 3 JP-2008-25474-A
PTL 4 JP-2008-128133-A
PTL 5 JP-4149322-B
PTL 6 JP-2007-107426-A
PTL 7 JP-4331136-B

### SUMMARY OF INVENTION

### Technical Problem

In the water jacket spacer disclosed in PTL 2, the flow volume of cooling water in the water jacket can be appropriate, the spacer can be facilitated to be inserted and assembled in the water jacket, and can be stably kept in the water jacket, and furthermore, the temperature in up and down directions in the cylinder bore wall can be uniform. However, the structure of the regulation part disclosed in PTL 2 is complicated, so that it cannot be easily produced and further improvements have been required to put it into practical use. The spacer disclosed in PTL 3, 4 has at the upper part a flow path separating member having substantially the same width as an open width (groove width) of the water jacket, or an elastically deformable flow path separating member having a little larger width than the open width. In addition, the spacer has the upward guiding member at its side part; however, such a flow path separating member becomes obstacle for inserting the spacer in the water jacket and it is difficult to insert and assemble the spacer. Furthermore, the spacer disclosed in PTL 5, 6 is provided at an appropriate part in the water jacket, mainly blocks flow path at the lower half in the water jacket and prevents non-uniform cooling up and down. However, PTL 5, 6 do not intend to rectify too much volume of cooling water in the water jacket, which is inherent in molding of the cylinder block, or to commonly use a cylinder block molding die for a plurality of engines, as mentioned above. The cooling regulating member disclosed in PTL 7 regulates the flow of cooling water and temperature in the cylinder bore wall by deformation caused by temperature change in the cooling water. However, in this case, such a cooling regulating member is qualitatively different from a spacer which is designed to rectify too much volume of cooling water in the water jacket, which is inherent in molding the cylinder block, and to commonly use one cylinder block molding die for a plurality of engines.

The present invention is proposed in view of the above-mentioned problems and has an object to provide a water jacket spacer which can regulate the flow volume of cooling water in the water jacket depending on the specification and the like of engines and can easily achieve uniform cooling effect in the water jacket.

### Solution to Problem

According to the present invention, a water jacket spacer is adapted to be inserted into a water jacket of a cylinder block, for regulating flow volume of cooling water in the water jacket. The water jacket spacer comprises a spacer body molded in conformity to the shape of the water jacket and a regulating member whose one side is fixed to the spacer body. The regulating member is a complex structure composed of a first member which is not water-swellable and is elastically deformable and a second member made of water-swellable elastomer which is integrally fixed to the first member. The regulating member is configured such that it lies in a state not contacting an opposed wall of the water jacket when inserted into the water jacket together with the spacer body, whereas it blocks apart of cooling water flowing through the water jacket by deforming such that a side of the regulating member not fixed to the spacer body faces toward the opposed wall of the water jacket when the second member swells by absorbing cooling water flown into the water jacket and thereby the first member is elastically deformed.

In the water jacket spacer of the present invention, the complex structure constituting the regulating member may adopt the following three forms.

(1) The complex structure is a plate body whose one side is fixed to a side surface of the spacer body and deforms to be curved when the second member swells by absorbing cooling water.
(2) The complex structure is a spiral body whose base part is fixed to a side surface of the spacer body and deforms to be enlarged outward when the second member swells by absorbing cooling water.
(3) The complex structure is a zigzag body whose base part is fixed to a side surface of the spacer body and deforms such that a folded angle of the zigzag body is enlarged when the second member swells by absorbing cooling water.

In the water jacket spacer of the present invention, the regulating member may be fixed to the spacer body in such a manner that the regulating member is disposed at a deep part in an insertion direction of the regulating member when the regulating member is inserted into the water jacket. Furthermore, the first member may be made of non-swellable rubber.

### ADVANTAGEOUS EFFECTS OF INVENTION

The water jacket spacer of the present invention is provided for regulating flow volume of cooling water in the water jacket, so that enlarging volume of cooling water in the water jacket, which is inherent in molding the cylinder block, can be appropriately prevented by suitably setting the width of the spacer body. In addition, single kind of molding die for a cylinder block can be facilitated to be commonly used for a plurality of engines. The regulating member constituted with the complex structure of the first member which is not water-swellable and elastically deformable and the second member made of water-swellable elastomer which is integrally fixed to the first member is designed so as to lie in a state not contacting the opposed wall of the water jacket when being fitted in the water jacket together with the spacer body. Therefore, when the water jacket spacer is inserted in the water jacket, the regulating member does not become obstacle and assembly can be smoothly done. In addition, the second member swells by absorbing cooling water flowing in the water jacket, the first member is elastically deformed by the swelling, then the non-fixed part of the regulating member is deformed into the direction of the opposed wall, thereby regulating a part of cooling water flowing in the water jacket. By such regulation, cooling effect of the cylinder block in the water jacket can be easily made uniform. The regulating member has such a simple structure that it is constituted with the complex structure of the first member which is not water-swellable and elastically deformable and the second member made of water-swellable elastomer which is integrally fixed to the first member and one side is fixed to the spacer body, thereby the regulating member can be easily produced.

In one embodiment of the water jacket spacer of the present invention in which the complex structure constituting the regulating member is a plate body, one side of the plate-like body is fixed to the side surface of the spacer body, and the plate body is designed to curve when the second body swells by absorbing water; the regulating member is deformed in such a manner that the non-fixed part faces toward the opposed wall of the water jacket by the curved deformation of the plate body, thereby accurately regulating a part of cooling water flowing in the water jacket. In another embodiment the complex structure is a spiral body of which base part is fixed to the side surface of the spacer body, and the spiral body is designed to deform in radially outward direction when the second member swells by absorbing water. The regulating member is deformed in such a manner that the non-fixed part faces toward the opposed wall of the water jacket by the enlarged deformation of the spiral body, thereby accurately regulating a part of cooling water flowing in the water jacket. Furthermore, in another embodiment in which the complex structure is a zigzag body of which base part is fixed to the side surface of the spacer body, and the spiral body is designed to deform such that a folded angle is enlarged when the second member swells by absorbing water, the regulating member is deformed in such a manner that the non-fixed part faces toward the opposed wall of the water jacket, thereby accurately regulating a part of cooling water flowing in the water jacket.

In one embodiment of the water jacket spacer of the present invention in which the regulating member is fixed to the spacer body so as to be positioned at the deep part in the fitting direction when the water jacket spacer is fitted in the water jacket, the deep part corresponds to the lower part of the cylinder bore, namely where a piston reciprocates, so that overcooling therearound can be prevented, thereby keeping smooth reciprocation of the piston. On the other hand, the opposite part to the deep part of the engine block in the fitting direction is at the upper part of the cylinder bore, namely a place close to the combustion chamber, so that cooling water is not regulated by the regulating member therearound and it can achieve sufficient cooling effect, thereby appropriately achieving uniform cooling effect of the cylinder bore all over the water jacket.

In addition, in another embodiment of the water jacket spacer in which the first member is made of not water-swellable rubber, the complex structure with the second member made of water-swellable elastomer can be easily produced by simultaneous molding.

### BRIEF DESCRIPTION OF DRAWINGS

FIG. 1 is a diagrammatical entire perspective view showing one embodiment of a water jacket spacer according to the present invention.

FIG. 2 is a traverse plan view of a cylinder block in which the water jacket spacer is fitted in a water jacket.

FIG. 3a is an enlarged view of the portion marked with “X” in FIG. 2 and FIG. 3b shows the state when cooling water flows in the water jacket.

FIG. 4a is a partially broken perspective view where a regulating member of the water jacket spacer is provided and FIG. 4b is the similar view of a modified embodiment.

FIG. 5a and FIG. 5b are similar views to FIG. 3a and FIG. 3b in another embodiment.

FIG. 6a and FIG. 6b are similar views to FIG. 3a and FIG. 3b in another embodiment.

FIG. 7a and FIG. 7b are similar views to FIG. 3a and FIG. 3b in still another embodiment.

FIG. 8a is an enlarged view of one embodiment in which a regulating member is provided for the portion marked with “Y” in FIG. 2, and FIG. 8b shows the state when cooling water flows in the water jacket.

FIG. 9a and FIG. 9b are similar views to FIG. 8a and FIG. 8b of the same portion shown in FIG. 8 in another embodiment.

FIG. 10a and FIG. 10b are similar views to FIG. 8a and FIG. 8b of the same portion shown in FIG. 8 in another embodiment.

### DESCRIPTION OF EMBODIMENTS

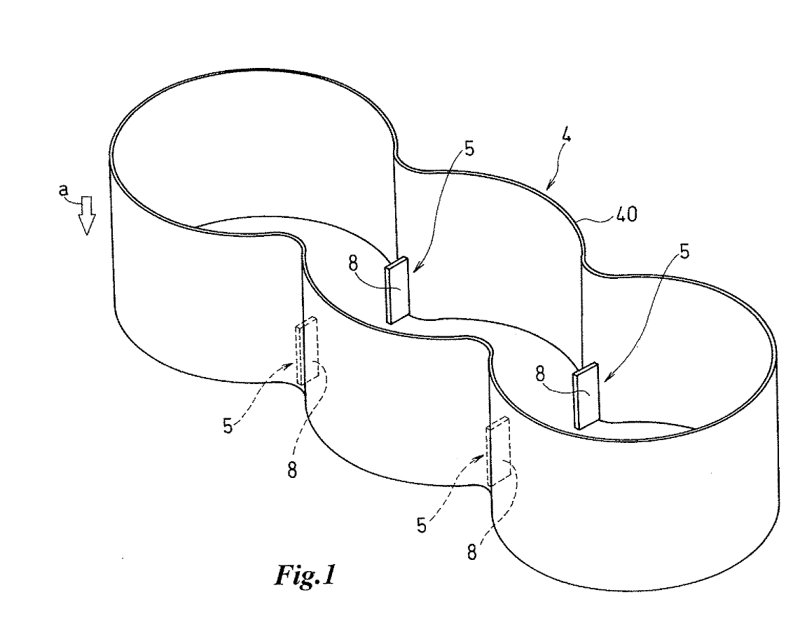

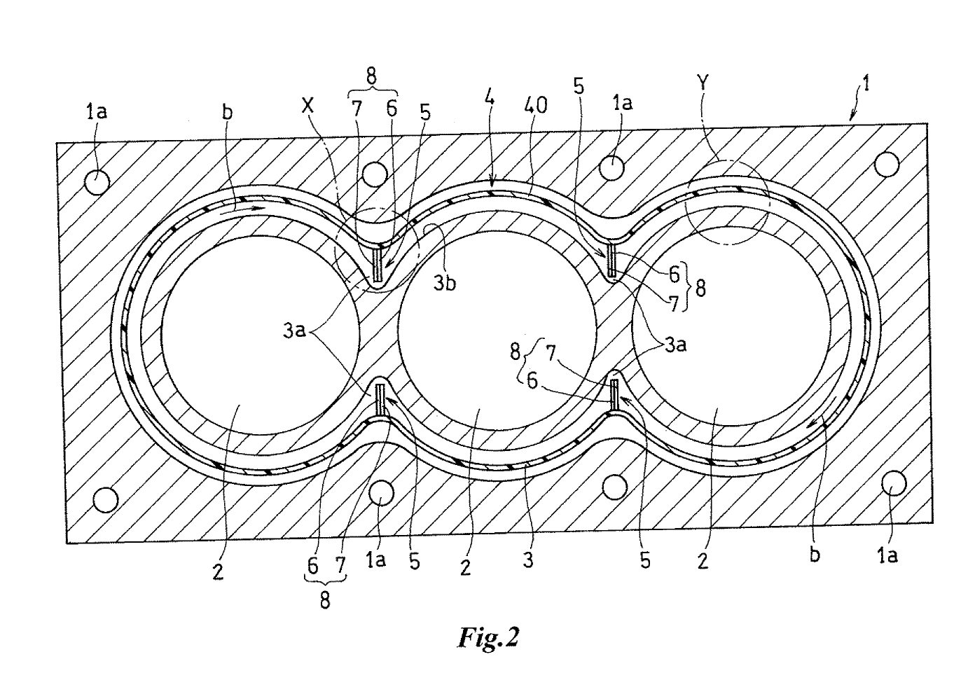

The embodiments of the present invention are explained based on the drawings. FIG. 1 is a diagrammatical entire perspective view showing one embodiment of a water jacket spacer according to the present invention. FIG. 2 is a diagrammatic traverse plan view of a cylinder block of a water-cooled engine having a water jacket to which a water jacket spacer is fitted. A cylinder block 1 shown in FIG. 2 is used for a three-cylinder engine and has three cylinder bores 2 aligned serially. An open-deck type water jacket 3 is formed around the three cylinder bores 2 in the form of bottomed groove and the upper end of the cylinder block 1 (surface which is integrated with the cylinder head, not illustrated) is opened. Actually, the cylinder block 1 is casted in aluminum alloy and the like, so that the water jacket 3 is formed with a male casting mold. The upper surface of the cylinder block 1 has a plurality of female screw holes 1a . . . for integrally fixing the cylinder head, not illustrated, by fastening with bolts. A constricted part 3a having larger groove width than that of other part is formed between adjacent cylinder bores 2 of the water jacket 3.

A supply portion and a discharge portion of cooling water to the water jacket 3 are not shown in FIG. 2.

The water jacket spacer 4 shown in FIG. 1 is constituted with a molded body made from synthetic resin and comprises a spacer body 40 and a regulating member 5 fixed to the spacer body 40, in which the spacer body 40 is formed like a loop corresponding to the shape of the water jacket 3 so as to be fitted in the water jacket spacer 3 with some free clearance from the upper opening. The regulating member 5 is fixed at a position which is an inner side of the spacer body 40 corresponding to the constricted part 3a and is the deep part in a fitting direction “a” to the water jacket 3, namely at the bottom side of the water jacket 3. The regulating member 5 is constituted with a complex structure 8 comprising a first member 6 made of non-water-swellable rubber and a second member 7 made of water-swellable elastomer integrally fixed to the first member 6. Synthetic rubber such as ethylene-propylene-diene rubber is preferably adopted as non-water-swellable rubber constituting the first member 6. The first member is not limited to rubber; rubber elastic resin such as polyisobutylene, polyethylene, polypropylene; and elastic metal and the like can be adopted. Elastomer blended with water-absorbing high-polymer material is adopted as water-swellable elastomer constituting the second member 7. Specifically, synthetic rubber such as ethylene-propylene-diene rubber (EPDM), and rubber-like elastic resin such as polyisobutylene, polyethylene, and polypropylene, in which copolymerization bridged compound of polyacrylate series or isobutyl maleic acid series or water-absorbing high-polymer material of polyethylene oxide series is blended, are preferably adopted.

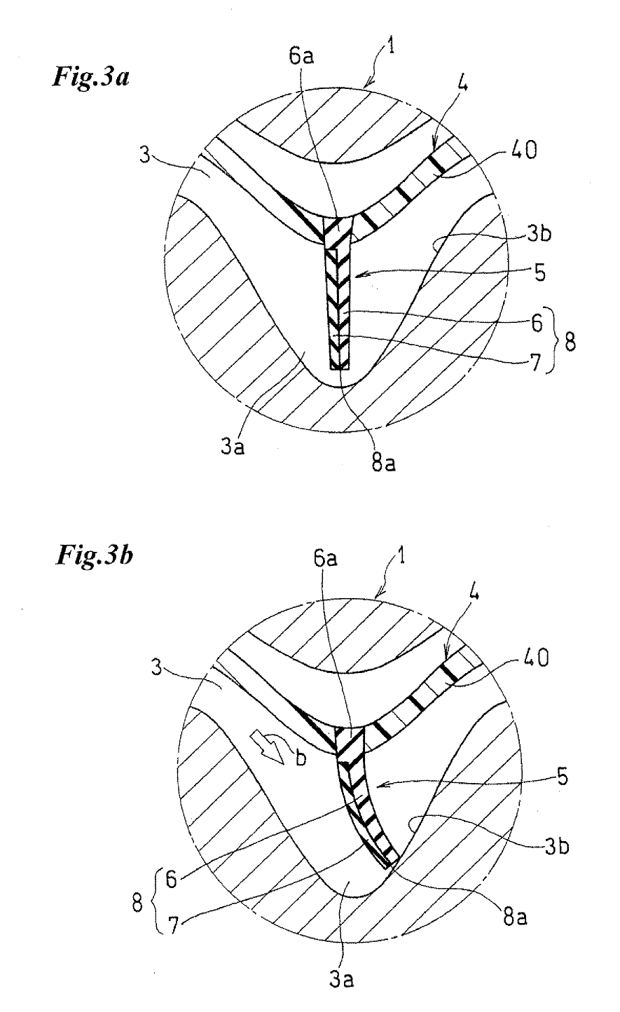

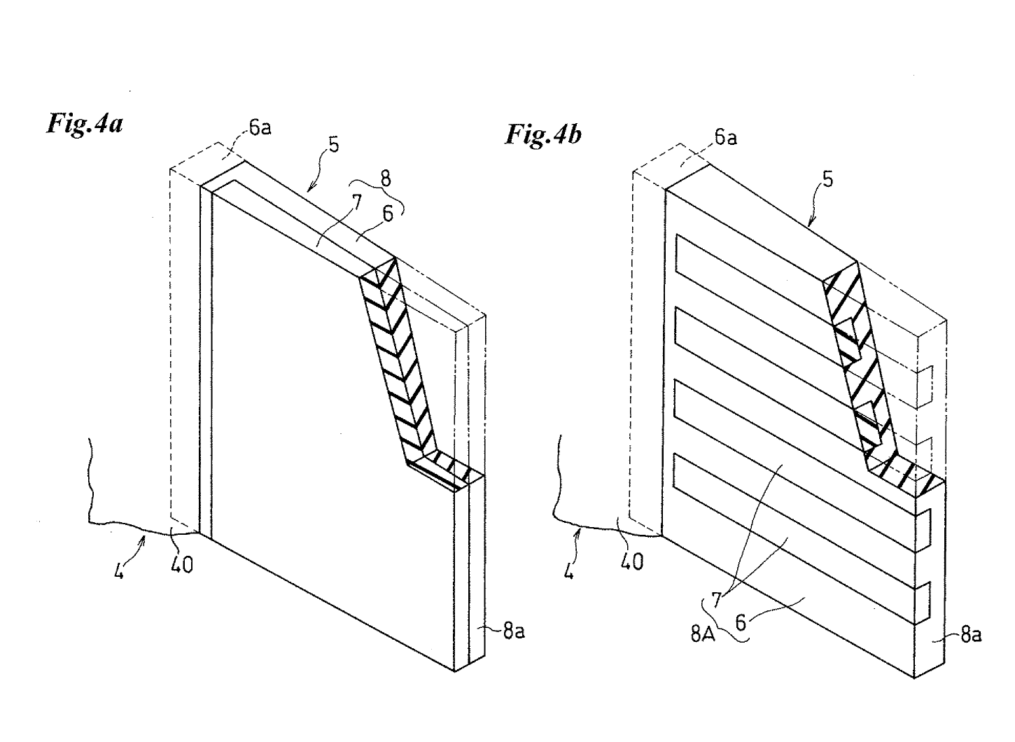

As shown in FIG. 3a and FIG. 4a, the complex structure 8 in this embodiment is a rectangular plate-like body formed by integrally fixing the sheet-like first member 6 and the sheet-like second member 7 in layer in a direction orthogonal to the fitting direction “a”, in which a base part 6a of the first member 6 constituting one side part (one side) of the plate-like body along the fitting direction “a” is fixed so as to be embedded in the spacer body 40. The first member 6 and the second member 7 are integrally fixed by simultaneous molding and the like. The base part 6a is fixed to the spacer body 40 by fitting-in, adhesion, or fixation with an appropriate stopper, and in addition, the base part 6a can be fixed by simultaneous molding together with the first member 6 and the second member 7 when the water jacket spacer 4 is molded. The complex structure 8 is designed in such a manner that the other side (non fixed side) 8a opposite to the one side faces toward the bottom of the constricted part 3a when the water jacket spacer 4 is fitted in the water jacket 3, but it lies in a state not contacting the wall portion (opposed wall portion 3b) of the constricted part 3a including the bottom. Accordingly, when the water jacket spacer 4 is fitted in the water jacket 3, the regulating member 5 constituted with the complex structure 8 does not become obstacle of fitting operation, thereby improving efficiency of assembly procedure of engines. Specifically, the constricted part 3a has large space because of its shape characteristic comparing to other parts, so that it is effective as a part where the regulating member 5 is provided under non-contact state to the opposed wall of the water jacket 3. The opposing wall 3b of the water jacket 3 is a wall part on the side of the cylinder bore 2.

FIG. 3b shows that the water jacket spacer 4 is fitted in the water jacket 3 as shown in FIG. 2 and FIG. 3a and the engine is assembled, cooling water (including cooling water mixed with antifreeze liquid) is supplied in the water jacket 3 and cooling water flows therein. The arrow “b” (also refer to FIG. 2) shows flow direction of cooling water. When cooling water thus flows in the water jacket 3, the second member 7 is swollen by absorbing cooling water. The second member 7 is integrally fixed to the first member 6 which is non-water-swellable and elastically deformable, so that the complex structure 8 is deformed like bimetal in such a manner that the first member 6 is elastically deformed accompanied with swelling of the second member 7, and the other side 8a is curved in right direction as shown in FIG. 3b and elastically contacts the opposed wall 3b of the water jacket 3. As a result, cooling water flowing around the contacting portion is blocked. In the water jacket spacer 4 of the embodiment of the present invention, the regulating member 5 is provided at the lower portion, so that flow of cooling water where a piston reciprocates is regulated and there is no warry for overcooling the wall of the cylinder bore 2 at the reciprocating portion. On the other hand, the regulating member 5 is not provided at the upper half of the water jacket spacer 4, so that the flow of cooling water is not blocked and the wall of the cylinder bore 2 close to a combustion chamber is adequately cooled, thereby achieving appropriate cooling function all over the wall of the cylinder bore 2.

FIG. 4b shows a modified embodiment of the regulating member 5 shown in FIG. 4a. In FIG. 4a, because the regulating member 5 is constituted with the complex structure 8 formed by integrating the sheet-like first member 6 and the sheet-like second member 7, the second member 7 is swollen by water in the surface area direction and the regulating member 5 curves in the fitting direction “a”, thereby irregular curved shape may be formed. In a complex structure 8A shown in FIG. 4b, the second member 7 is formed like a belt extending from the one side (base part 6a) to the other side 8a, and a plurality of belts are vertically aligned in parallel and integrated with the first member 6. In such designed complex structure 8A, the second member 7 is swollen by water mainly in the longitudinal direction, so that the curved shape hardly becomes irregular, thereby easily achieving ideal deformation of the regulating member 5 in such a manner that the other side 8a faces toward the opposed wall 3b of the water jacket 3.

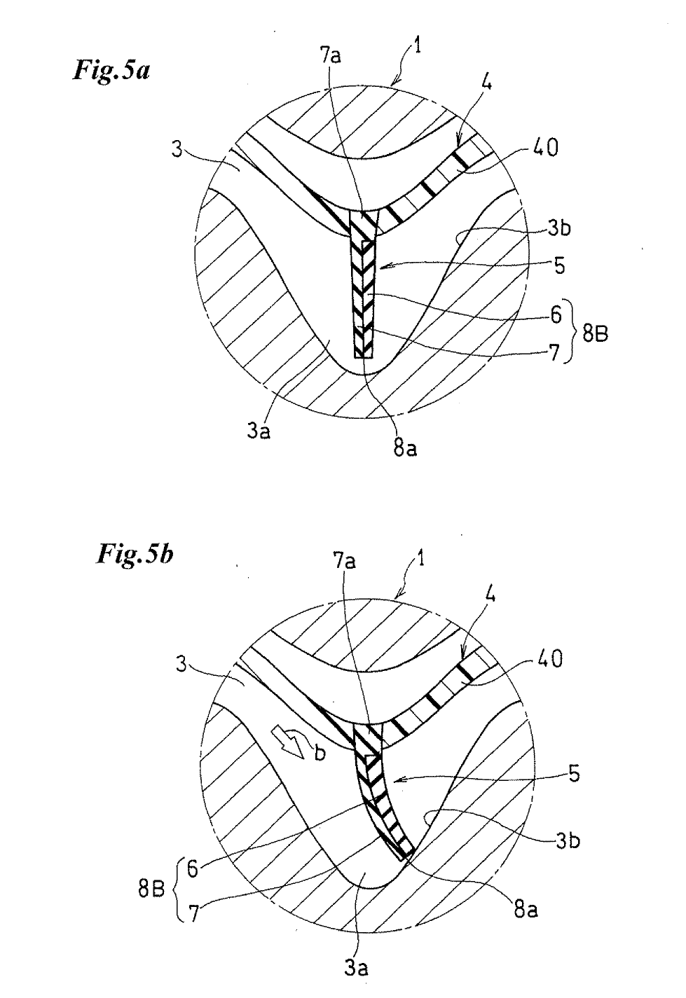

FIG. 5a and FIG. 5b show another modified embodiment of the regulating member 5. A complex structure 8B constituting the regulating member 5 comprises plate bodies like the complex bodies 8, 8A; however, it is different in that the second member 7 is fixed so as to be embedded in the spacer body 40 via a base part 7a as one side part (one side). When cooling water flows in the water jacket 3 (refer to the arrow “b”) as shown in FIG. 5b, the second member 7 swells by absorbing water, the complex structure 8B is deformed accompanying elastic deformation of the first member 6, the other side 8a comes into elastic contact with the opposed wall of the water jacket 3, thereby blocking cooling water flowing around the contacting portion as mentioned above. Integrally fixed structure of the first member 6 and the second member 7 may be either FIG. 4a or FIG. 4b in this case; if the structure is as shown in FIG. 4b, ideal deformation of the regulating member 5 can be easily achieved.

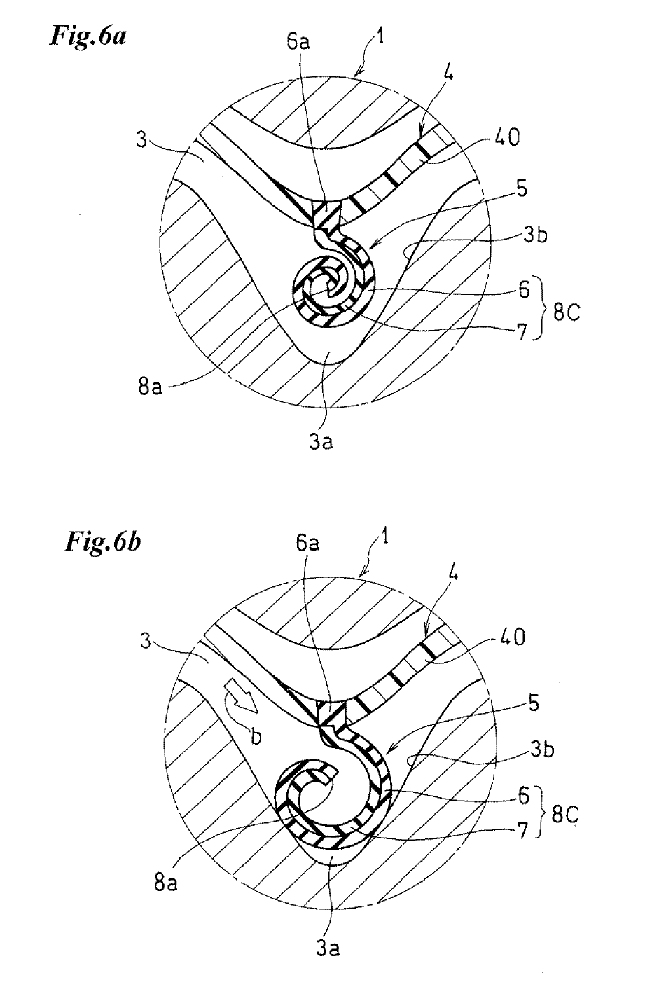

FIG. 6a and FIG. 6b show another modified embodiment of the regulating member 5. A complex structure 8C constituting the regulating member 5 is fixed to the spacer body 40 via the base part 6a of the first member 6 as shown in FIG. 3. The complex structure 8C in this embodiment is formed by integrally fixing the first member 6 and the second member 7 like the embodiment shown in FIG. 4a or FIG. 4b and is also formed in a spiral body in such a manner that the other side 8a is wound in when seen in the fitting direction “a” (see FIG. 1) and the second member 7 becomes inside. The regulating member 5 constituted with the spiral complex structure 8C is formed in such a manner that when the water jacket spacer 4 is fitted in the water jacket 3 as shown in FIG. 6a, the member 5 lies in a state not contacting the opposed wall 3b of the water jacket 3. When cooling water flows in the water jacket 3 (refer to the arrow “b”) as shown in FIG. 6b, the second member 7 swells by absorbing water. In such a case, the second member 7 is inside the spiral body, the complex structure 8C is deformed so as to be outwardly enlarged in the radial direction accompanying elastic deformation of the first member 6 when the second member 7 swells, then the circumferential face of the complex structure 8C comes into elastic contact with the opposed wall 3b of the water jacket 3. Accordingly, cooling water flowing around the contacting portion is blocked and the same function as mentioned above can be achieved.

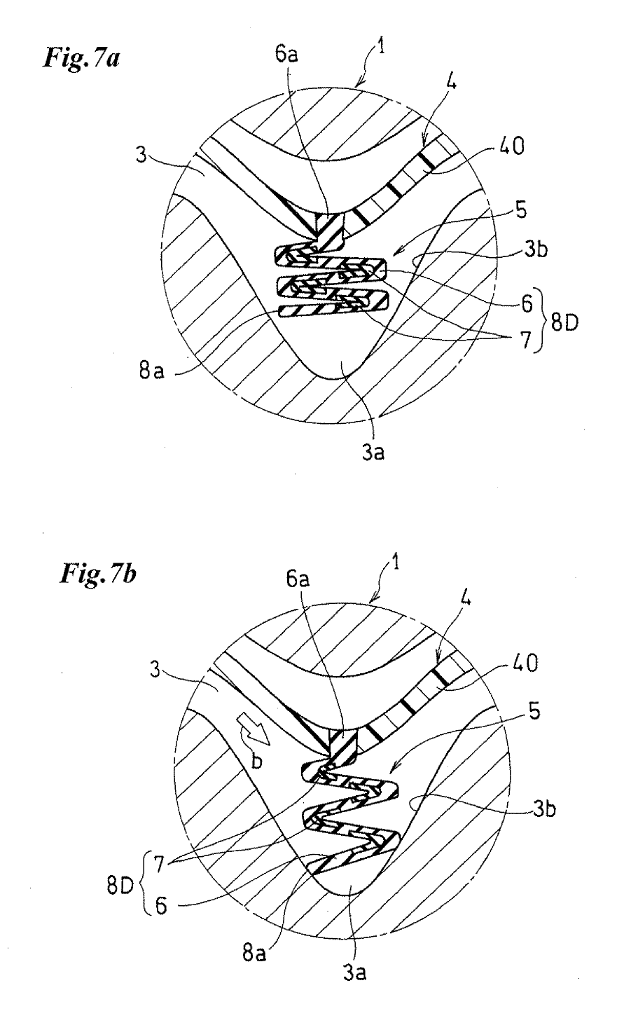

FIG. 7a and FIG. 7b show another modified embodiment of the regulating member 5. A complex structure 8D constituting the regulating member 5 is fixed to the spacer body 40 via the base part 6a of the first member 6 like the embodiment in FIG. 3. The complex structure 8D is formed in a zigzag body when seen in the fitting direction “a” (refer to FIG. 1). The first member 6 is serially formed in zigzag into the other side 8a; however, the second member 7 is not continuous so as to be positioned inside each folded part (at four parts in the figure) and is integrally fixed to the first member 6. The regulating member 5 constituted with such a zigzag complex structure 8D is formed so as to lie in a state not contacting the opposed wall 3b of the water jacket 3 when the water jacket spacer 4 is fitted in the water jacket 3. When cooling water flows in the water jacket 3 as shown in FIG. 7b (refer to the arrow “b”), the second member 7 swells by absorbing water. In such a case, the second member 7 is positioned inside each folded part of the zigzag body, and the complex structure 8D is deformed in such a manner that the folded angle of each folded part becomes large accompanying elastic deformation of the first member 6 when the second member 7 swells, thereby the other side 8a and the adjacent angled part of the complex structure 8D elastically come into contact with the opposed wall 3b of the water jacket 3. Accordingly, cooling water flowing around the contacting portion is blocked and the same functions as mentioned above can be achieved.

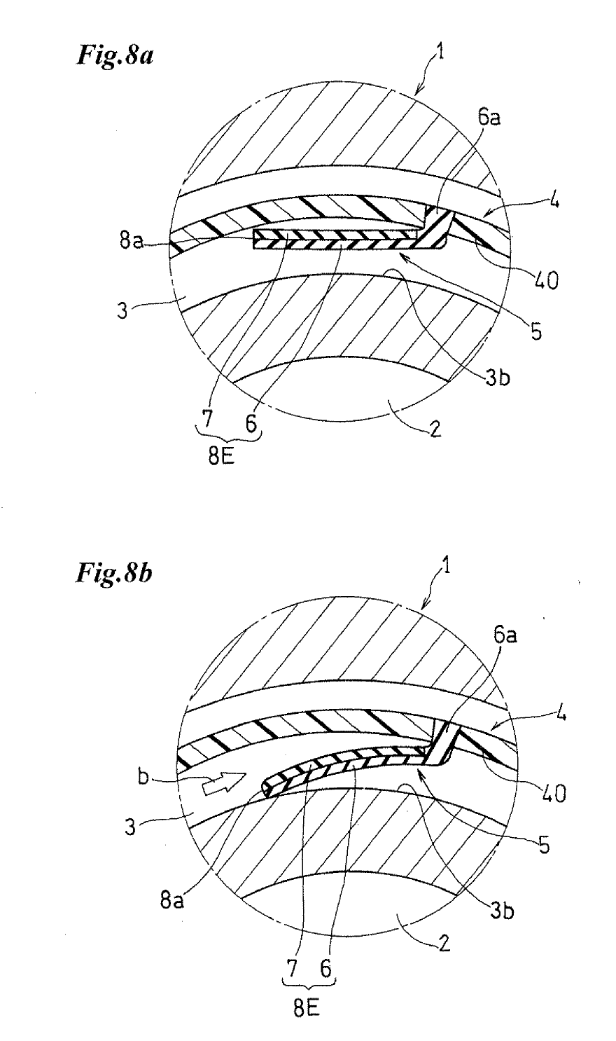

FIG. 8a is an enlarged view of one embodiment in which the regulating member is provided at the portion marked with “Y” in FIG. 2, and in FIG. 8b cooling water flows in the water jacket and the regulating member is deformed. The portion “Y” in FIG. 2 indicates an example in which the groove widths of the water jacket 3 other than the constricted part 3a are substantially the same and it means that the regulating member can be used in the part other than the constricted part 3a. A complex structure 8E constituting the regulating member 5 is fixed to the spacer body 40 via the base part 6a of the first member 6 like the embodiment in FIG. 3. The first member 6 is formed such that it is folded from the base part 6a, substantially along the inner wall of the spacer body 40, and the other side 8a faces the flow direction of cooling water (refer to the arrow “b” in FIG. 8b). The second member 7 is integrally fixed to the side facing the spacer body 40 of the first member 6 and the first member 6 is formed like a plate from the folded part to the other side 8a. Integrated structure of the first member 6 and the second member 7 can adopt the same structures as shown in FIG. 4a or FIG. 4b. When the water jacket spacer 4 is fitted in the water jacket 3 as shown in FIG. 8a, the regulating member 5 constituted with the plate-like complex structure 8E is formed so as not to contact the opposed wall 3b of the water jacket 3. When cooling water flows in the water jacket 3 (refer to the arrow “b”) as shown in FIG. 8b, the second member 7 swells by absorbing water. The regulating member 5 is deformed so as to roll back following the elastic deformation of the first member 6 by such swelling, and the other side 8a comes into elastic contact with the opposed wall 3b of the water jacket 3. Thereby cooling water flowing around the contacting portion can be blocked and the same function as mentioned above can be achieved.

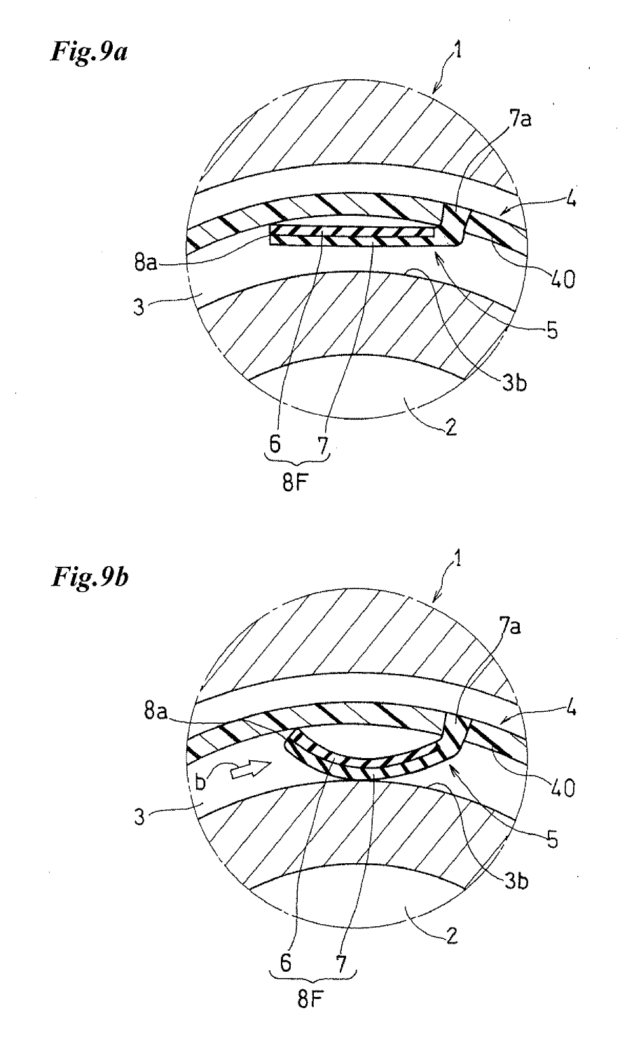

FIG. 9a and FIG. 9b show another embodiment of the regulating member 5 at the same portion as shown in FIG. 8. A complex structure 8F constituting the regulating member 5 in this embodiment is fixed to the spacer body 40 via the base part 7a of the second member 7 like the embodiment in FIG. 5. The second member 7 is formed such that it is folded from the base part 7a substantially along the inner wall of the spacer body 40, and the other side 8a faces the flow direction of cooling water (refer to the arrow “b” in FIG. 9b). The first member 6 is integrally fixed on the side facing the spacer body 40 of the second member 7 and the second member 7 is formed like a plate from the folded part to the other side 8a. Integrated structure of the first member 6 and the second member 7 can adopt the same structure as shown in FIG. 4a or FIG. 4b. When the water jacket spacer 4 is fitted in the water jacket 3 as shown in FIG. 9a, the regulating member 5 constituted with the plate-like complex structure 8F is formed to lie in a state not contacting the opposed wall 3b of the water jacket 3. When cooling water flows in the water jacket 3 (refer to the arrow “b”) as shown in FIG. 9b, the second member 7 swells by absorbing water. The regulating member 5 is curved in direction opposite to that of the embodiment in FIG. 8 accompanying elastic deformation of the first member 6 when the second member 7 swells and the curved part in the middle comes into elastic contact with the opposed wall 3b of the water jacket 3. Thereby cooling water flowing around the contacting portion can be blocked and the same function as mentioned above can be achieved.

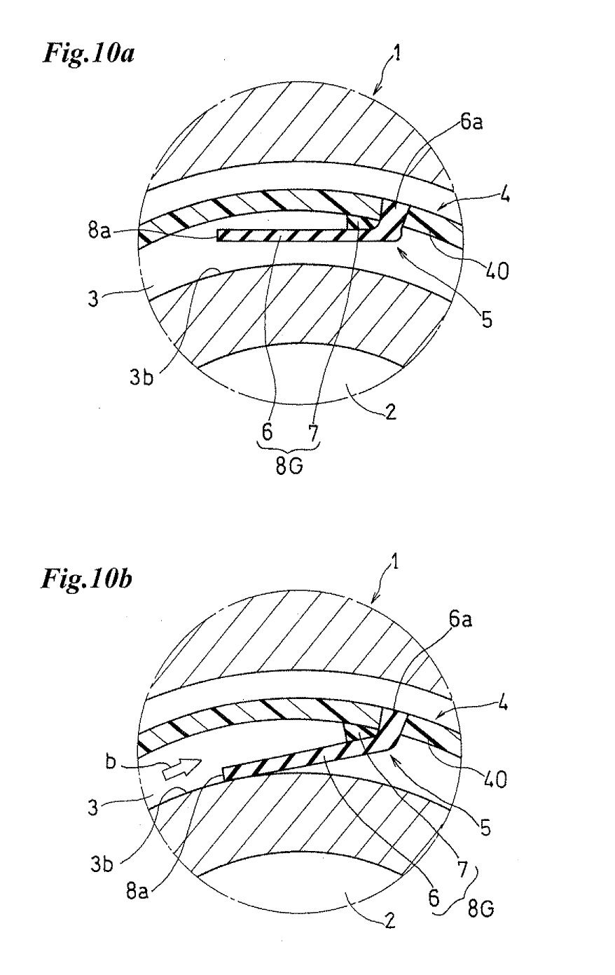

FIG. 10a and FIG. 10b show another embodiment of the regulating member at the same portion as shown in FIG. 8. A complex structure 8G constituting the regulating member 5 is fixed to the spacer body 40 via the base part 6a of the first member 6 like the embodiment in FIG. 8. The first member 6 is formed such that it is folded from the base part 6a and the other side 8a faces the flow direction of cooling water (refer to the arrow “b” in FIG. 10b). The second member 7 is integrally fixed to both of or either of the first member 6 and the spacer body 40 inside the folded part of the first member 6. When the water jacket spacer 4 is fitted in the water jacket 3 as shown in FIG. 10a, the regulating member 5 constituted with the plate-like complex structure 8G is formed so as to lie in a state of not contacting the opposed wall 3b of the water jacket 3. When cooling water flows in the water jacket 3 (refer to the arrow “b”) as shown in FIG. 10b, the second member 7 swells by absorbing water. In this embodiment the second member 7 is integrally fixed to both of the first member 6 and the spacer body 40, such a swollen second member 7 operates on the first member 6 to be pushed into the opposed wall 3b and the first member 6 is elastically deformed so as to widen the angle at the folded part. The regulating member 5 is deformed by the elastic deformation of the first member 6, and the other side 8a comes into elastic contact with the opposed wall 3b of the water jacket 3. Thereby cooling water flowing around the contacting portion can be blocked and the same function as mentioned above can be achieved.

The regulating members shown in FIG. 1 to FIG. 7 and the regulating members shown in FIG. 8 to FIG. 10 can be appropriately combined and used. The height of the regulating member (length along the fitting direction “a”) is not limited to that shown in FIG. 1 and can be appropriately set depending on the required cooling performance based on the specification of engines. In addition, FIG. 1 and FIG. 2 show the water jacket spacer of the present invention is applied to three-cylinder engines; however, the present invention is not limited to such a case. Furthermore, the water jacket spacer shown in the figures may have cutouts for flowing cooling water between inside and outside thereof, or have a guide member for guiding cooling water from bottom to top. One side of the regulating member is fixed to the spacer body along the fitting direction of the water jacket spacer to the water jacket in the above-mentioned embodiments; however, the direction is not limited as far as it is orthogonal to the flow direction of cooling water. For example, if flow direction of cooling water slants vertically depending on the guiding member, the one side is fixed along the direction orthogonal to the flow direction in order to effectively achieve rectifying operation by the regulating member. In addition, the above-mentioned modified embodiments show the non-fixed part comes into elastic contact with the opposed wall when the regulating member is swollen by water; however it cannot contact the opposed wall but it can come close to it.

### REFERENCE SIGNS LIST

1 cylinder block
3 water jacket
3b opposed wall
4 water jacket spacer
40 spacer body
5 regulating member
6 first member
7 second member
6a, 7a base part (one side)
8, 8A to 8G complex structure
8a other side (non-fixed part)
a fitting direction
b flow direction of cooling water

1. A water jacket spacer adapted to be inserted into a water jacket of a cylinder block, for regulating flow volume of cooling water in said water jacket, comprising:
a spacer body molded in conformity to the shape of said water jacket; and
a regulating member whose one side is fixed to said spacer body;
wherein said regulating member is a complex structure composed of a first member which is not water-swellable and is elastically deformable and a second member made of water-swellable elastomer which is integrally fixed to said first member; and
said regulating member is configured such that it lies in a state not contacting an opposed wall of said water jacket when inserted into said water jacket together with said spacer body, whereas it blocks a part of cooling water flowing through said water jacket by deforming such that a side of said regulating member not fixed to said spacer body faces toward said opposed wall of said water jacket when said second member swells by absorbing cooling water flown into said water jacket and thereby said first member is elastically deformed.

2. The water jacket spacer as set forth in claim 1 wherein: said complex structure is a plate body whose one side is fixed to a side surface of said spacer body and deforms to be curved when said second member swells by absorbing cooling water.

3. The water jacket spacer as set forth in claim 1 wherein: said complex structure is a spiral body whose base part is fixed to a side surface of said spacer body and deforms to be enlarged radially outward when said second member swells by absorbing cooling water.

4. The water jacket spacer as set forth in claim 1 wherein: said complex structure is a zigzag body whose base part is fixed to a side surface of said spacer body and deforms such that a folded angle of said zigzag body is enlarged when said second member swells by absorbing cooling water.

5. The water jacket spacer as set forth in claim 1 wherein: said regulating member is fixed to said spacer body in such a manner that said regulating member is disposed at a deep part in an insertion direction of said regulating member when said regulating member is inserted into said water jacket.

6. The water jacket spacer as set forth in claim 1, wherein said first member is made of non-swellable rubber.

7. The water jacket spacer as set forth in claim 2, wherein said first member is made of non-swellable rubber.

8. The water jacket spacer as set forth in claim 3, wherein said first member is made of non-swellable rubber.

9. The water jacket spacer as set forth in claim 4, wherein said first member is made of non-swellable rubber.

10. The water jacket spacer as set forth in claim 2 wherein: said regulating member is fixed to said spacer body in such a manner that said regulating member is disposed at a deep part in an insertion direction of said regulating member when said regulating member is inserted into said water jacket.

11. The water jacket spacer as set forth in claim 3 wherein: said regulating member is fixed to said spacer body in such a manner that said regulating member is disposed at a deep part in an insertion direction of said regulating member when said regulating member is inserted into said water jacket.

12. The water jacket spacer as set forth in claim 4 wherein: said regulating member is fixed to said spacer body in such a manner that said regulating member is disposed at a deep part in an insertion direction of said regulating member when said regulating member is inserted into said water jacket.
